(19) United States
(12) Patent Application Publication
(10) Pub. No.: US 2003/0009766 A1
(43) Pub. Date: Jan. 9, 2003

(54) Person-to-person scheduling and notification of automatic program recording for personalized television

(75) Inventor: Andrew Vincent Marolda, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/900,217

(22) Filed: Jul. 6, 2001

(51) Int. Cl. H04N 7/173

(52) U.S. Cl. 725/97; 725/88

(57) ABSTRACT

The present invention provides techniques to allow person-to-person scheduling of automatic program recording for personalized television. Generally, a first person (called a “scheduler” herein) schedules a program to be recorded by a personalized television recorder controlled by a second person (called a “recipient” herein). It is determined if the scheduler is authorized to scheduler a recording on behalf of the recipient. If so, the program is recorded unless there is a conflict with another program or if other conditions are met.

### FIELD OF THE INVENTION

The present invention relates to television, and more particularly, to person-to-person scheduling and notification of automatic program recording for personalized television.

### BACKGROUND OF THE INVENTION

Recently, personalized television recorders have gained popularity. These systems contain a hard-drive and allow a live television program to be recorded, paused, and rewound. Additionally, they generally come with program guides that provide detailed descriptions and schedules of television programming. Using the program guide, a person can simply select a television program to record.

Some of the more advanced personalized television recorders will determine preferences of users and record programs based on the preferences. For instance, if a person frequently watches tennis, the personalized television recorder may record sports programs about tennis, even though the person never asked for the programs to be recorded. Additionally, these personalized television recorders can automatically record programs based on advertised promotions of future programs. The advertised promotion is compared with the preferences of the user, and, if there is a match, the recorder will schedule the future program for recording.

This process has some limitations. First, the profile-based process is performed by methods that, while they take into account a variety of factors, are fixed and relatively simplistic. For instance, should the tastes of the user suddenly change, the method will take some time to learn the new preferences. Additionally, if the user preferences change such that the former preferences are no longer applicable, the method has to “unlearn” these former preferences. This unlearning process takes time.

Moreover, these methods are singular, meaning that the method determines preferences for only one person. There is no way for two friends, for instance, to share preferences and television programs.

Finally, most of the profile-based methods for determining user preferences use some measure of similarity to determine if the user would enjoy a program. For example, if a user enjoys tennis matches, a program about a tennis player would be deemed similar to tennis matches and therefore recorded. However, it is possible that a user would actually enjoy a program that is completely different from tennis. The present methods that make profile-based program suggestions will not be able to determine this preference.

A need therefore exists for techniques that allow faster preference updating and sharing of television programs between individuals.

### SUMMARY OF THE INVENTION

The present invention provides techniques to allow person-to-person scheduling of automatic program recording for personalized television. Generally, a first person (called a “scheduler” herein) schedules a program to be recorded by a personalized television recorder controlled by a second person, such as a friend, colleague, or member of a common interest group (collectively called a “recipient” herein). It is determined if the scheduler is authorized to schedule a recording on behalf of the recipient. If so, the program is recorded unless there is a conflict with another program or if other conditions are met.

The present invention has an advantage that two people with similar interests will generally also have similar television viewing preferences. This similarity is often more accurate than what can be obtained through profile-based methods. Additionally, the present invention allows one person to schedule recordings of television programs in which another person might be interested. This has a benefit that a friend, for example, may be able to have a person watch programs that the person would not watch except for the scheduling suggestion by the friend. Thus, a person could watch and enjoy a television program that is unlike anything he or she has watched before. This type of unexpected result is something that cannot be obtained by profile-based recording methods. Moreover, the present invention allows feedback and notes to be passed between schedulers and recipients. Schedulers can determine when and if programs were watched and how the recipients enjoyed the television program.

A more complete understanding of the present invention, as well as further features and advantages of the present invention, will be obtained by reference to the following detailed description and drawings.

### BRIEF DESCRIPTION OF THE DRAWINGS

FIG. 1 is a flowchart of a method for person-to-person scheduling and notification of automatic program recording for personalized television, in accordance with a preferred embodiment of the invention; and

FIG. 2 is a block diagram of a system for person-to-person scheduling and notification of automatic program recording for personalized television, in accordance with a preferred embodiment of the invention.

### DETAILED DESCRIPTION

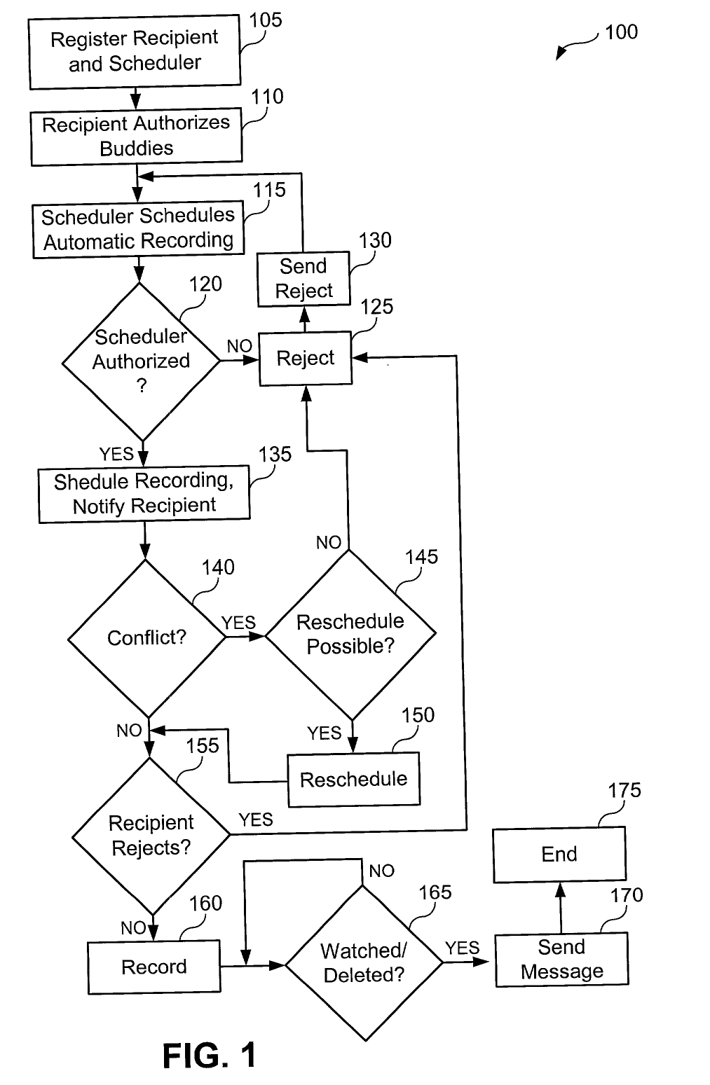

Referring to FIG. 1, a method 100 is shown for person-to-person scheduling and notification of automatic program recording for personalized television, in accordance with a preferred embodiment of the invention. Method 100 is used by a system to schedule television programs for a recipient. Basically, a first person (a “scheduler”) schedules a television program for a personalized television recorder, owned by or available to a second person (a “recipient”), to record. For the television program to be recorded, the recipient has to have given permission for the scheduler to be allowed to schedule recording on his or her behalf. If the recipient has not given this permission, the scheduling will not be performed. If the recipient has given this permission, the television program will be recorded by the personalized television recorder of the recipient. Notification may be given to the scheduler and the recipient at many different points during this process.

In the discussion that follows, a personalized television recorder is any device that can be scheduled to record a television program (or to initiate the recording of a television program, such as functions in a set-top terminal that initiate recording with a video cassette recorder). While this definition includes video cassette recorders, in general a personalized television recorder will have a hard-drive or other quickly addressable, long-term memory, such as recordable optical storage. Additionally, the personalized television recorder will be considered to be “owned” by the recipient. This means that the recipient has access to and permission to use a personalized television recorder. For instance, the parents of a teenager may actually own a personalized television recorder, but the teenager may be allowed to use the personalized television recorder and, consequently, allow friends and acquaintances with permission to schedule recordings on the personalized television recorder.

Method 100 begins, in step 105, when a recipient and a scheduler are registered. In one embodiment of the present invention, the scheduler must be authorized by the recipient to schedule recordings on the personalized television recorder of the recipient. Generally, a service provider will provide a program through which the recipient and scheduler can register. The recipient can then authorize the scheduler to make scheduled recordings on his or her behalf. The service provider acts as an intermediary and will validate authorizations and send commands to the personalized television recorder owned by the recipient. This has the benefit that a centralized location is used for registration and authorization. In another embodiment, each personalized television recorder will contain the authorization and registrations, and the personalized television recorder itself will determine if a request to record a program comes from an authorized person.

In step 110, the recipient authorizes one or more people to allow them to schedule recordings on his or her personalized television recorder. This is generally performed through a “buddy list,” indicating which acquaintances of the recipient are allowed to schedule program recordings on the personalized television recorder owned by the recipient. The buddy list will usually be maintained and created in a central location, but could be maintained and created on each personalized television recorder.

In step 115, a person schedules a television program to be recorded on the personalized television recorder owned by the recipient. There are a variety of techniques suitable for scheduling an automatic recording. Most personalized television recorders periodically access a service provider to receive information about what programs are on television, schedules of when they are on, and information about each television program. A request to schedule a recording, on the personalized television recorder owned by the recipient, can be sent to a service provider. The service provider can then authorize the recording and schedule a message for the personalized television recorder owned by the recipient. When the personalized television recorder owned by the recipient accesses the service provider, the message authorizing and directing a recording will also be accessed and received. The personalized television recorder will then record the television program.

Alternatively, a request to schedule a program for recording may also be sent directly to a personalized television recorder. The personalized television recorder will then determine whether the sender has permission to schedule a recording, and, if so, will then record the program at the proper time.

Optionally in step 115, the scheduler can record a note that is to be delivered to the recipient. For instance, the note might state, “I thought that you might enjoy this program. It relates to our discussion at work. Let's get together tomorrow for further discussion.” This note will be delivered to the personalized television recorder owned by the recipient.

In step 120, it is determined if the person who is scheduling the recording is authorized to schedule a recording. Generally, this is performed by accessing a buddy list and determining if the scheduler is authorized for the particular recipient. It should be noted that there are a variety of techniques, known to those skilled in the art, for ensuring that an imposter cannot usurp the identity of the scheduler. These techniques may be used during this step.

If the scheduler is not authorized to schedule a recording for the recipient (step 120=NO), the request is rejected (step 125) and a rejection is sent (step 130). The rejection can be sent to both the recipient and the scheduler or just to the scheduler alone. The rejection can be transmitted through any means known to those skilled in the art. Generally, email will be used to send the rejection. However, the rejection can also be sent as a message directly to the personalized television recorder of the scheduler, the recipient, or both.

If the scheduler is authorized to schedule the recording (step 120=YES), the recording is scheduled on the personalized television recorder owned by the recipient (step 135). There are a variety of methods suitable for scheduling the recording. Generally, some type of message will be sent to the personalized television recorder. This message includes an identification of the television program to record, which could be a simple number that indicates the program, a time and channel, or other mechanisms known to those skilled in the art. Generally, some personalized television recorders schedule recordings based on the preferences of a user. The same type of recording system can be used to schedule the recording performed in step 135.

Additionally, in step 135, the recipient is optionally notified of the scheduling. This notification is usually performed through email, to an email address provided by the recipient. Alternatively, the notification can be through a notice delivered to the personalized television recorder owned by the recipient. In step 135, the scheduler may also be notified when the program is scheduled. This notification is also generally sent through email to an address provided by the scheduler and optionally to the personalized television recorder owned by the scheduler.

In step 140, it is determined if the scheduled program conflicts with another program. For instance, the recipient could be currently watching a program on a different channel than the channel that will be used for the scheduled program. In this case, the scheduled program will conflict with the preferences of the recipient. Additionally, the recipient may have already scheduled a program to view at the same time, or in an overlapping time slot, as the scheduled program is to be recorded. Most personalized television recorders only contain one receiver and can only record one program at a time. In these instances, (step 140=YES), it is determined if it is possible to reschedule the scheduled program (step 145).

For instance, if the scheduled program is played at a later time or at a later date (step 145=YES), the program can be rescheduled for that time or date (step 150). If the program cannot be rescheduled (step 145=NO), the scheduled recorder is rejected (step 125) and a rejection notification is sent (step 130) to the recipient, or scheduler, or both.

If there is no conflict (step 140=NO), it is also possible for the recipient to reject the scheduled recording. For instance, if the recipient receives an email outlining the scheduling, the recipient could reply, through the email, that he or she rejects the scheduling (step 155=YES). This can cause a rejection (step 125) and a notification of rejection (step 130). For example, the service provider could receive the email rejection and then either cancel the record request if it has not been sent or send a cancellation to the personalized television recorder owned by the recipient.

Additionally, the personalized television recorder can display a message when it schedules the recording. For instance, the personalized television recorder could display the following message: “There has been a request by Scheduler to record the program ‘The Best Country Artists of the Last 10 Years.’ Would you like this recorded?” If the recipient indicates or selects a “No” option (step 155=YES), the personalized television recorder will reject the scheduling (step 125) and a rejection will be sent (step 130). It should be noted that the personalized television recorder can schedule a rejection to be sent when the recorder accesses a service provider to get the program guides. When this access takes place, the rejection is sent (step 125), and the service provider itself then sends the actual rejection notification (step 130). Additionally, the rejection can be immediately sent.

If the recipient does not reject the scheduled recording (step 155=NO), the program will be recorded (step 160). If the recipient watches or deletes the recorded program without watching it (step 165=YES), the personalized television recorder will send a message (170) indicating the watching or deletion. The method 100 then ends in step 175. Again, this message may be sent immediately or scheduled for transmission when the program guide is accessed from the service provider.

Thus, FIG. 1 shows a method 100 that allows permitted individuals, including friends, colleagues and other individuals, to record television programs for each other. The method 100 also provides optional notification at many steps of the method.

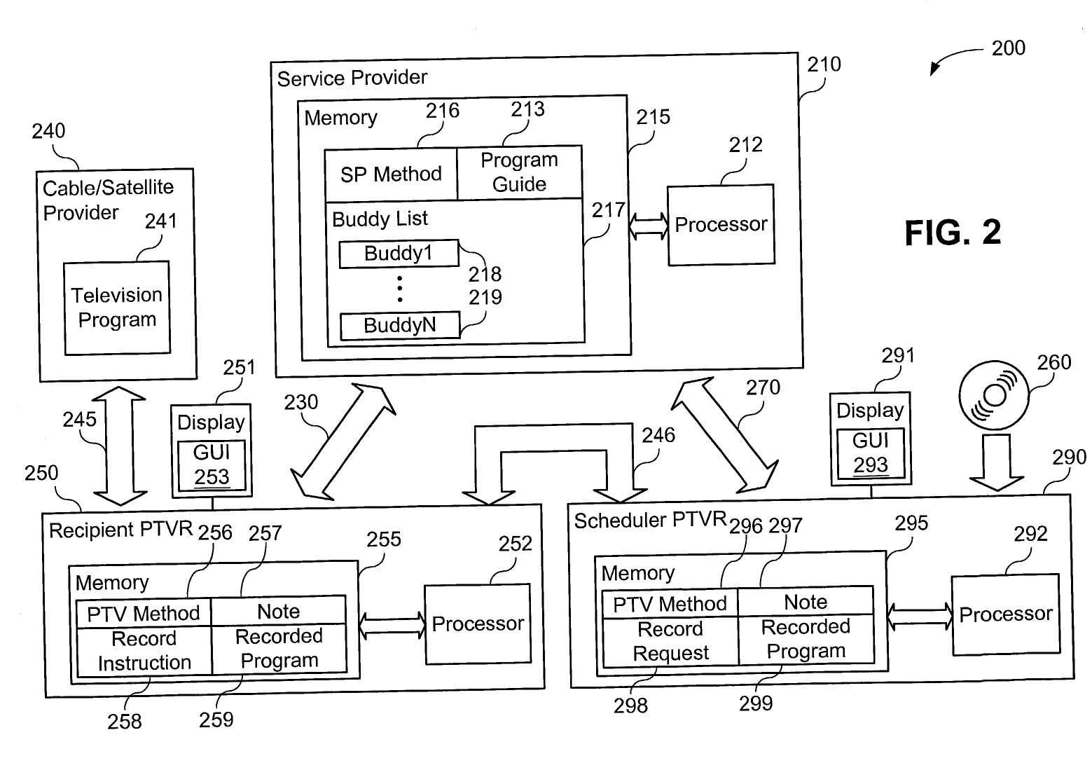

Referring now to FIG. 2, a system 200 is shown for person-to-person scheduling and notification of automatic program recording for personalized television, in accordance with a preferred embodiment of the invention. There are a variety of techniques suitable for authorizing people to schedule recordings on personalized television recorders, for scheduling the recordings, and for notifying schedulers and recipients. In the present television environment, personalized television service providers have centralized locations where program guides and other information reside. Each personalized television recorder accesses the centralized location to receive the program guides, updates to software, and other information. The system 200 is based on this type of structure. However, as technology increases and homes are wired for high-speed access, it becomes less necessary for a centralized structure. In this less-centralized system, personalized television recorders can communicate directly with each other.

System 200 comprises a service provider 210, communication links 230, 270, two personalized television recorders 250, 290, a cable/satellite television provider 240, a cable/satellite link 245, a recorder-to-recorder link 246, a Digital Versatile Disk (DVD) 260, and displays 251, 291. Service provider 210 comprises a memory 215 and at least one processor 212. Memory 215 contains a service provider method 216, a buddy list 217, which contains buddy entries 218 through 219, and a program guide 213. Recipient personalized television recorder 250 contains a memory 255 and a processor 252. Memory 255 contains a personalized television method 256, a note 257, a record instruction 258, and a recorded program 259. Scheduler personalized television recorder 290 comprises memory 295 and processor 292. Memory 295 comprises personalized television method 296, note 297, record request 298, and recorded program 299.

As is known in the art, service provider 210 contains a program guide 213 that personalized television recorders 250, 290 download. Additionally, the personalized television recorders 250, 290 can also download software updates (not shown) from service provider 210. Each communication link 230, 270 can be a satellite link, a land-based wired or wireless link, or both.

Service provider method 216 allows users to modify or create buddy lists on service provider 210. To support this, each personalized television recorder 250, 290 contains a personalized television method 256, 296 that provides a Graphical User Interface (GUI) 253, 293 on a display 251, 291. The GUI 253, 293 allows current lists of users to be displayed so that the recipient or scheduler can add a buddy to his or her buddy list.

In the example of FIG. 2, both the recipient and the scheduler register with service provider 210, by using personalized television methods 256, 296. Registration may be performed offline and then sent later to service provider method 216, which updates its list (not shown) of registered users. Alternatively, registration may be performed online and the service provider method 216 can immediately update its list of users. It should be noted that other types of registration are possible, such as registering through the Internet. This is also the case when creating or modifying buddy lists.

The recipient creates a buddy list 217 on service provider 210 by using personalized television method 256, which communicates with service provider method 216. The recipient creates buddy list 217, which has N buddies 218 through 219. Each buddy may be given a nickname, and there exists some method through which service provider method 216 can determine which personalized television recorder is associated with that buddy. Generally, when a person registers with the service provider method 216, the name of the user and identification of the personalized television recorder owned by the user will be determined. Most personalized television recorders contain a unique identification that is electronically ascertainable. In lieu of the identification, other mechanisms may be used to associate a particular personalized television recorder with a user. A phone number or internet address, for instance, can be used to identify a particular personalized television recorder. Any method for associating a user with a personalized television recorder may be used.

Buddy list 217 is a list of users who have been authorized to schedule television program recordings on recipient personalized television recorder 250. Each buddy entry 218, 219 contains the information used to identify a user and the personalized television recorder of the user.

Once the recipient and scheduler are registered with the service provider 210 and the recipient has created buddy list 217, users on the buddy list 217 may schedule recordings on recipient personalized television recorder 250.

A user, using scheduler personalized television recorder 290 and its personalized television method 296, creates a record request 298. The record request contains all information (not shown) useful in determining a particular program to record. Such information could include the name of the program, its channel or network, and timeslot. Any technique for determining a program may be used. Additionally, the recipient creates a note 297. The note 297 is optional. The note 297 may be the following: “I thought you would enjoy this program of ‘CarMag on TV,’ where the hosts discuss the car you are considering.” The note 297 and record request 298 are created with the help of GUI 293.

The note 297 and record request 298 are transmitted by personalized television recorder 290, through communication link 270, to service provider method 216. In this example, communication link 270 is a phone connection made to service provider 210. The service provider 210 determines the phone number of the phone connection used by personalized television 290, and therefore determines the user identification and personalized television recorder identification. Optionally, a user identification or a unique personalized television recorder identification or both may be transmitted through communication link 290.

When service provider method 216 receives the record request 298 from scheduler personalized television recorder 290, it determines if the scheduler is authorized to schedule recordings on recipient personalized television recorder 250. To determine this, service provider method 216 compares a recipient identification or a scheduler personalized television recorder identification, or both, with the buddy entries 218 through 219. If there is a match, the service provider method 216 sends a record instruction through communication link 230. This record instruction is downloaded to recipient personalized television recorder 250, through communication link 230. In the example of FIG. 2, communication link 230 is a satellite Radio Frequency (RF) link. The recipient personalized television recorder 250 downloads the program guide 213 and, at the same time, the record instruction 258. Downloading generally occurs every night or at other suitable times.

As explained above in reference to FIG. 1, if there is no match, the service provider method 216 usually sends a rejection to the scheduler personalized television recorder 290. Optionally, the rejection may also be sent to recipient personalized television recorder 250 or directly to the recipient or scheduler (e.g., through email).

In this example, the scheduler personalized television recorder 290 is listed in buddy list 217, so the recipient personalized television recorder 250 receives the record instruction 258. The record instruction 258 is any type of information that determines which program to record. This could contain channel information and a time span. For instance, the record instruction 258 could be one or more of the following: “Record channel 40 from 10:30 p.m. to 11:00 p.m.”; “Record Network at 10:00 a.m. to 12 p.m.”; or “Record ‘Program A’ on Network.”

The personalized television method 256 will record the program, as long as there is no conflict. To determine if there is a conflict, the personalized television recorder 250 will determine if the personalized television recorder is currently on a different channel when the program is to be recorded. If this is so, then the personalized television method 256 will not record the program. Optionally, the personalized television method 256 can ask the user watching the program if the personalized television can record the program defined by the record instruction 258.

Additionally, another program could be already scheduled for recording when the record instruction 258 is received. If both of these programs overlap in time, then the personalized television recorder 250 will not record the program defined by record instruction 258. Finally the personalized television recorder 250 can receive record instruction 258, but the recipient could decide to record another program that overlaps the program defined by record instruction 258. In this case, the personalized television recorder 250 also does not record the program defined by record instruction 258.

During any scenario when the personalized television recorder cannot record the program defined by the record instruction 258, the personalized television recorder 250 can optionally send a notification, using communication link 230, that the program was not recorded due to a conflict. Additionally, the personalized television recorder 250 can be configured to determine if the program defined by record instruction 258 can be rescheduled. Such a determination made be made by comparing a title of the record instruction 258 with titles of program in the stored program guide 213 in memory 255, or through other techniques known to those skilled in the art. If the program defined by record instruction 258 can be rescheduled, then personalized television recorder 250 will reschedule it and record it, subject to additional potential conflicts that arise later.

Additionally, the personalized television recorder 250 can display a message when it receives the record instruction 258. This message, as discussed above in reference to FIG. 1, may be used by the recipient to reject or accept the taping of the scheduled program. Also, the personalized television recorder 250 can display note 257, which is received by the recorder 250 as either part of record instruction 258 or as an addendum thereto.

In the example of FIG. 2, there are no conflicts or rejections, and recipient personalized television recorder 250 records the television program and stores it in memory 255 as recorded program 259. To record the program, the recipient personalized television recorder 250 receives the television program 214 through cable/satellite link 245. As it receives the television program 214, the recipient personalized television recorder 250 records it to memory 230. As is known in the art, the recording may be compressed. It should be noted that cable/satellite provider 240 and service provider 210 may be the same entity or separate entities.

It should be noted that the techniques used for ordering the recipient personalized television recorder to record a command are only possible techniques. Other techniques may be used. For example, the service provider method 216 could pass the record request 298 to the recipient personalized television recorder 250, but add an addendum that indicates that the scheduler has permission (or does not have permission) to schedule a recording. The recipient personalized television recorder 250 then would determine whether to send a notification of the permission (or rejection) or place such a notification on display 251.

Recorder-to-recorder link 246 is optional. This link is a “direct” link between the two recorders 250, 290. For instance, both recorders 250, 290 could be Internet addressable, and each recorder could communicate through Internet protocols. With link 246, a scheduler can perform a direct transfer from recorder 290 to recorder 250. The buddy list 217 would be used in the following manners. The scheduler would send a request (record request 298) to service provider method 216 through communication link 270. The service provider method 216 then ensures that the recorder 290 is on the list of buddies in buddy list 217, and authorizes a transfer. The authorization is sent to recorder 290, which then “pushes” or transmits a recorded program 299 to recorder 250 through link 246. This transmission generally occurs so that the recorder 290 transmits until the entire program 299 is transferred.

Additionally, the recorded program 299 can be streamed from the scheduler personalized television recorder 290 to the recipient personalized television recorder 250, provided that there is a communications link either directly between the two recorders 250, 290 (e.g., via Internet Protocol and communication link 246) or indirectly through the service provider 210. Streaming is a process where the recorder 290 acts similar to a server in that the recorder 290 will send information upon request by the recorder 250.

Another embodiment is for a number of recipients to pay for the recorded program 299. The recipients are authorized by service provider 210 through buddy list 217. To be entered in buddy list 217, each person must pay a certain amount. Each recipient then communicates directly with scheduler personalized television recorder 290 to receive recorded program 299. For example, recipient personalized television recorder 250 can request permission from service provider 210 to receive recorded program 299 from recorder 290. The service provider method 216 will determine that recorder 250 or the recipient are in buddy list 217 and send a command to recorder 290 to authorize reception by recorder 250 of the recorded program 299. When the recorder 250 receives a request from recorder 250 for the recorded program 299, the recorder can begin to transmit the recorded program 299.

Alternatively, recipient personalized television recorder 250 can directly request permission from scheduler personalized television recorder 290 to be able to access recorded program 299. The recorder 290 can determine, either through access to service provider 210 or through its own copy of buddy list 217, whether the recipient personalized television recorder or the recipient has permission to access the recorded program 299. The scheduler personalized television recorder 290 should inform service provider 210 when the recorder 290 has granted permission for a recipient to have access to a program, who the recipient or personalized television recorder is, and which program has been accessed.

In these embodiments, users are placed in buddy list 217 if they have paid. The payment could be for particular content (e.g., a certain movie or program) or could be a subscription payment to be able to access the personalized television recorder of a scheduler. In the case where the payment is for particular content, the buddy list 217 would be specifically for the recorded program 299. If a person is not on the buddy list 217, then this person cannot access the recorded program 299. The service provider 210 mediates this process by allowing the scheduler to register the recorded program 299. The service provider 201 creates a buddy list 217 specific to the program and personalized television recorder 290. The service provider 210 then collects payments from users who wish to view the recorded program 299. Payments will usually be shared with the studio or studios (or other entities) that own the distribution and copyrights to the recorded program 299.

In the case where the payment is made to be able to access the personalized television recorder 290, the service provider 210 allows those individuals who are listed in buddy list 217 to have access to the recorded program 299. Once a subscription is over for a user, he or she is removed from the buddy list. To ensure that copyright owners or distribution owners get a fair share of the payment, the scheduler personalized television recorder 290 can send information to the service provider 210. This information can include which recipients (or recorders) have accessed which programs and for how many times.

The methods disclosed herein allow individuals to record and share television programs, yet ensure that copyright and distribution rights are not adversely effected. The copyright owner or distribution rights owner should still receive a fair share of profits from the viewing of the material.

As is known in the art, the methods and apparatus discussed herein may be distributed as an article of manufacture that itself comprises a computer-readable medium having computer-readable code means embodied thereon. The computer-readable code means is operable, in conjunction with a computer system such as personalized television recorder 250, 290 or service provider 210, to carry out all or some of the steps to perform the methods or create the apparatus discussed herein. The computer-readable medium may be a recordable medium (e.g., floppy disks, hard drives, DVD 260, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk, such as DVD 260. As shown in FIG. 2, the DVD 260 can load instructions into personalized television recorder 290, but DVD 260 could also be used with recorder 250 and service provider 210.

Memories 215, 255, and 290 are long-term, short-term, or a combination of long- and-short term memories. These memories configure processors 212, 252, and 292, respectively, to implement the methods, steps, and functions disclosed herein. These memories 215, 255, and 290 could be distributed or local and the processors 212, 252, and 292 could be distributed or singular. The memories 215, 255, and 290 could be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network is still within memory 250, for instance, because the processor 252 can retrieve the information from the network. It should also be noted that some or all of recorders 250, 290 or service provider 210 can be incorporated into an application-specific or general-use integrated circuit.

Thus, FIGS. 1 and 2 detail an invention that allows people to share television recordings and that allows people to direct personalized television recorders to record programs for others. There are multiple opportunities for notification, such that the users may be apprised of their requests and of the results of their requests.

It is to be understood that the embodiments and variations shown and described herein are merely illustrative of the principles of this invention and that various modifications may be implemented by those skilled in the art without departing from the scope and spirit of the invention.

What is claimed is:

1. A method for automatic recording, the method comprising the steps of:
receiving a request, from a scheduler, to schedule a recording of a program for a recipient; and
issuing a command to record the program for the recipient, wherein the scheduler and the recipient are different individuals.

2. The method of claim 1, further comprising the step of determining if the scheduler is authorized to schedule a recording for the recipient, and wherein the step of issuing a command to record the program for the recipient further comprises the step of issuing a command to record the program for the recipient when the scheduler is authorized to schedule a recording for the recipient.

3. The method of claim 2, wherein the step of determining if a scheduler is authorized to schedule a recording for the recipient further comprises the step of determining if the scheduler matches an entry in a buddy list.

4. The method of claim 3, wherein the step of determining if the scheduler matches an entry in a buddy list further comprises the step of determining if a scheduler identification matches one of a plurality of identifications in the buddy list.

5. The method of claim 3, wherein the step of determining if the scheduler matches an entry in a buddy list further comprises the step of determining if a scheduler personalized television recorder identification matches one of a plurality of identifications in the buddy list.

6. The method of claim 3, wherein the method further comprises the steps of:
registering the recipient;
registering the scheduler; and
creating a buddy list for the recipient, the buddy list comprising at least one entry, each entry determining a person allowed to authorize recordings on a personalized television recorder owned by the recipient.

7. The method of claim 2, wherein the steps of receiving, determining, and issuing are performed by a service provider.

8. The method of claim 7, further comprising the step of accepting a monetary amount, and wherein the step of issuing further comprises the step of issuing a command to record the program for the recipient when the scheduler is authorized to schedule a recording for the recipient and when the monetary amount meets a predetermined amount.

9. The method of claim 2, wherein the steps of receiving, determining, and issuing are performed by a personalized television recorder.

10. The method of claim 2, wherein:
the step of determining if a scheduler is authorized to schedule a recording for the recipient further comprises the step of determining if the recipient matches an entry in a buddy list, wherein each entry in the buddy list has paid to be on the list; and
the step of issuing a command to record the program for the recipient when the scheduler is authorized to schedule a recording for the recipient further comprises the step of issuing a command, by a service provider, to a scheduler personalized television recorder to allow a recipient personalized television recorder to retrieve a recorded program from the scheduler personalized television recorder when the recipient matches an entry in the buddy list.

11. The method of claim 10, further comprising the step of the recipient personalized television recorder retrieving the recorded program from the scheduler personalized television recorder.

12. The method of claim 10, further comprising the step of the scheduler personalized television recorder transmitting the recorded program to the recipient personalized television recorder.

13. The method of claim 1, further comprising the step of informing one or more of the scheduler and the recipient that the command has been issued.

14. The method of claim 2, further comprising the step of informing one or more of the scheduler and the recipient when the scheduler is not authorized to schedule a recording for the recipient.

15. The method of claim 1, further comprising the steps of:
receiving the issued command;
determining if a conflict exists between the command and a previously entered recording request; and
rejecting the command when a conflict exists.

16. The method of claim 1, further comprising the steps of:
receiving the issued command;
determining if a conflict exists between the command and a program being watched; and
rejecting the command when a conflict exists.

17. A system comprising:
a memory that stores computer-readable code; and
a processor operatively coupled to the memory, the processor configured to implement the computer-readable code, the computer-readable code configured to:
receive a request, from a scheduler, to schedule a recording of a program for a recipient; and
issue a command to record the program for the recipient, wherein the scheduler and the recipient are different individuals.

18. An article of manufacture comprising:
a computer-readable medium having computer-readable code means embodied thereon, said computer-readable program code means comprising:
a step to receive a request, from a scheduler, to schedule a recording of a program for a recipient; and
issue a command to record the program for the recipient, wherein the scheduler and the recipient are different individuals.

19. A system for person-to-person scheduling and notification of automatic program recording for personalized television, the system comprising:
means for receiving a request, from a scheduler, to schedule a recording of a program for a recipient; and
means for issuing a command to record the program for the recipient, wherein the scheduler is a first person and the recipient is a second person.

20. A method performed on a recorder capable of recording programs, the method comprising the steps of:
receiving an instruction from a scheduler to schedule a recording of a program for a recipient, wherein the scheduler and the recipient are different individuals; and
recording the program.

21. The method of claim 20, wherein:
the step of receiving an instruction from a scheduler to schedule a recording of a program for a recipient further comprises the steps of:
the scheduler requesting the recording of the program; and
determining if the scheduler is authorized to schedule the recording for a recipient; and
the step of recording the program further comprises the step of recording the program when the scheduler is authorized to schedule the recording for the recipient.

22. A system comprising:
a memory that stores computer-readable code; and
a processor operatively coupled to the memory, the processor configured to implement the computer-readable code, the computer-readable code configured to:
receive an instruction from a scheduler to schedule a recording of a program for a recipient, wherein the scheduler and the recipient are different individuals; and
record the program.

23. A method comprising the steps of:
a scheduler selecting a program for a recipient, wherein the scheduler and the recipient are different individuals;
forming an instruction suitable to allow recording of the program; and
transmitting the instruction.
